(19) United States
(12) Patent Application Publication
(10) Pub. No.: US 2003/0041174 A1
(43) Pub. Date: Feb. 27, 2003

(54) Data exchange for two software systems co-existing on a computer

(75) Inventors: Sayling Wen, Taipei (TW); Kuang Shin Lin, Nan Kai (TW); Guei-Long Guo, Nan Kai (TW); Gang Fan, Nan Kai (TW)

Correspondence Address: Mitchell P. Brook, Baker & McKenzie, 12th Floor, 101 West Broadway, San Diego, CA, 92101-3890, US

(73) Assignee: INVENTEC CORPORATION

(21) Appl. No.: 09/938,805

(22) Filed: Aug. 24, 2001

(51) Int. Cl. G06F 15/16; G06F 7/00; G06F 17/30

(52) U.S. Cl. 709/248; 709/231; 707/10

(57) ABSTRACT

A data exchange system is disclosed for exchanging data between two software systems running on a computer for maintaining data consistency in databases in the two software systems in real-time. The data exchange system comprises a first and a second data-exchanging software systems. The first data-exchanging software system operates as an application software under the Microsoft Windows or Linux operating system of the computer and comprises an OS data synchronization module, an OS data exchange module, an OS exchange databank, and an OS standard-format databank. The second data-exchanging software system operates as another application software under the One-Touch OS™ operating system and comprises an AP data synchronization module, an AP data exchange module, an AP exchange databank, and an AP standard-format databank. The OS data exchange module accesses information stored in the AP standard-format databank for comparison with information stored in the OS exchange databank. The OS data synchronization module synchronizes the compared information designated by a user of the computer, and the AP data exchange module accesses information stored in the OS standard-format databank for comparison with information stored in the AP exchange databank. The AP data synchronization module synchronizes the compared information designated by the user.

### FIELD OF THE INVENTION

This invention relates in general to computer data exchange and, in particular, to a data exchange system for two co-existing software systems residing on a computer.

### BACKGROUND OF THE INVENTION

Conventional operating systems (OS) for personal computers (PC) such as commercial Microsoft Windows and freeware Linux are in general full-fledged operating systems capable of many and various functionalities. Feature-rich and sophisticated they may be, however, those very features and sophistication themselves also constitute, on many occasions, serious psychological barriers for computer-novices. These barriers automatically arise for many novice users as they attempt to use the computer not only because the typical PC OS is complex and feature-laden, but also because there are at least several procedural steps to take before any of the more simple and intuitive computer applications can be launched and used.

To power up a computer and bring up an application, a user has to boot up the system, access the physical interface of the system via devices such as a keyboard and/or mouse, locate the whereabouts of the particular application software from the desktop icon array, and then actually launch the application.

Even after the user has successfully brought the desired software application up and running, the process of using the application will most likely involve interacting with the application via one or more of several forms of user interfaces. Sometimes, a combination of these interfaces will have to be used. Typical of these user interfaces are graphical (GUIs) and multimedia types initiated through the use of a mouse, keyboard, microphone, and the like. However, since almost all of the most popular software application programs are marketed in English versions, and even the non-English version software programs inevitably contain English messages in the interfaces they provide, for non English-speaking or barely literate users, even these popular GUIs and other multimedia interfaces constitute obstacles to computer access and productive use.

Thus, an easy-to-use computer application software system should look and feel friendly and be encouraging rather than frightening. A friendly and encouraging application system should be fool-proof in that the user knows he or she will never physically damage the computer, crash the OS, or lose data simply by attempting different commands on the computer. A simple computer application system is therefore desirable for those intending to learn and use computers for the first time and then for simple daily activities such as keeping phone numbers and addresses, web browsing, and many other intuitive applications.

### SUMMARY OF THE INVENTION

An easy-to-use application software system aimed at providing hands-on experience and initiating the learning of computer use for computer novices has the functionality for processing daily-life computer applications that a computer-novice desires. Functionalities provided by such an easy-to-use application software system include the ability to process handy personal information such as phone numbers and addresses, take notes in texts or in drawings, provide basic communication services including telephone, facsimile, electronic mailing, chatting service over the network, and access to the popular World Wide Web over the Internet. The system also provides easy-to-use application systems for convenient learning and recreational sessions such as tutoring for personal skills such as language and typing, game playing, as well as audio and video playback.

The present invention provides an application system working in a cooperative manner with a normal full-featured OS providing user friendliness and an encouraging mood for computer novices or even illiterates.

As a user gains experience through continuous use of one of the above-mentioned easy-to-use application systems, it is possible to move on to the more powerful computer working environment provided by OS such as Windows or Linux. The database built up by a novice user in the easy-to-use application software system is re-usable in the regular OS environment when the novice eventually becomes an experienced computer user.

It is therefore an objective of the present invention to provide a data exchange system that facilitates smooth data exchange between a host operating system and an easy-to-use application software system so that both may maintain a consistent database in real-time.

It is another objective of the present invention to provide a data exchange system that facilitates smooth data exchange between a host operating system and an easy-to-use application software system so that one software system may make use of the data established and maintained by the other.

The present invention achieves the above-identified objectives by providing a data exchange system for exchanging data between two software systems running on a computer for maintaining data consistency in databases in the two software systems in real-time. The data exchange system comprises a first and a second data-exchanging software systems. The first data-exchanging software system operates as an application software under the operating system of the computer and comprises an OS data synchronization module, an OS data exchange module, an OS exchange databank, and an OS standard-format databank. The second data-exchanging software system operates as another application software under the operating system and comprises an AP data synchronization module, an AP data exchange module, an AP exchange databank, and an AP standard-format databank. The OS data exchange module accesses information stored in the AP standard-format databank for comparison with information stored in the OS exchange databank. The OS data synchronization module synchronizes the compared information designated by a user of the computer, and the AP data exchange module accesses information stored in the OS standard-format databank for comparison with information stored in the AP exchange databank. The AP data synchronization module synchronizes the compared information designated by the user.

In a data exchange system for exchanging data between two software systems running on a computer, the computer having an operating system for maintaining data consistency in a plurality of databases in the two software programs in real-time, and the data exchange system comprising a first and as second data-exchanging software system wherein the first data-exchanging software system comprising an OS data synchronization module, an OS data exchange module, an OS exchange databank and an OS standard-format databank, and the second data-exchanging software system comprising an AP data synchronization module, an AP data exchange module, an AP exchange databank and an AP standard-format databank, the present invention also provides a method for exchanging data between two software systems of the data exchange system. The method comprises the steps of having the first and second data-exchanging software systems operating as application software under the operating system of the computer, and the OS data exchange module accessing information stored in the AP standard-format databank for comparison with information stored in the OS exchange databank, and the OS data synchronization module synchronizing the compared information designated by a user of said computer, and the AP data exchange module accessing information stored in the OS standard-format databank for comparison with information stored in the AP exchange databank, and the AP data synchronization module synchronizing the compared information designated by the user.

### BRIEF DESCRIPTION OF THE DRAWINGS

Other objects, features and advantages of this invention will become apparent by way of the following detailed description of the preferred but non-limiting embodiments. The description is made with reference to the accompanying drawings in which:

FIG. 1 is a block diagram illustrating a data exchange system for the exchange of data between two software systems in accordance with a preferred embodiment of the invention;

FIG. 2 is flowchart illustrating the program flow of the data synchronization module for the data exchange system of FIG. 1;

FIG. 3 is a flowchart illustrating the program flow of the data exchange module for exchanging data in the application software system of FIG. 1.

FIG. 4 is a flowchart illustrating the program flow of the data exchange module for exchanging data in the operating system of FIG. 1;

FIG. 5 is a flowchart illustrating the program flow of the operating system file access module for the data exchange system of FIG. 1; and

FIGS. 6-9 respectively show selected screen shots of an embodiment of the data exchange system of the invention in the process of handling of mail messages.

### DETAILED DESCRIPTION OF THE INVENTION

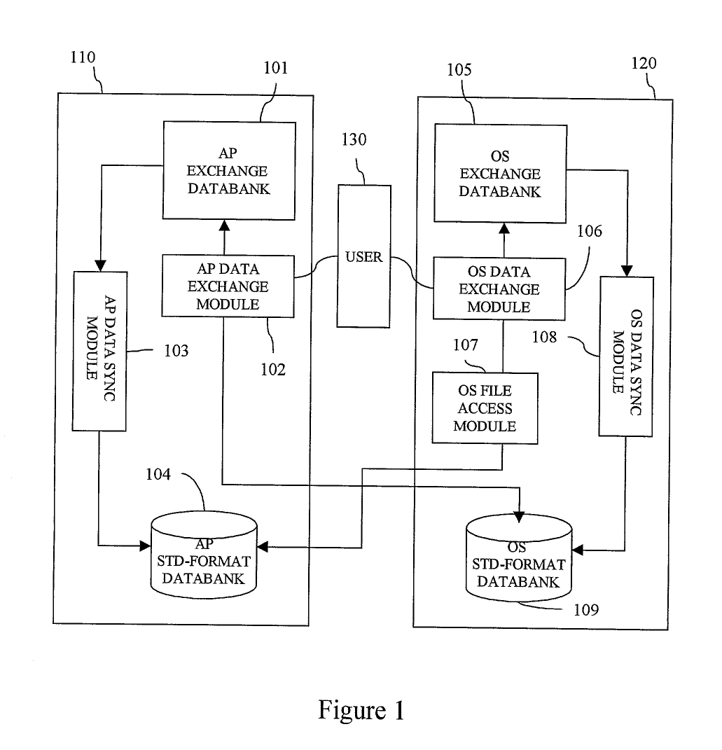

FIG. 1 is a block diagram illustrating the configuration of a data exchange system for implementing exchange of data between two software systems in accordance with a preferred embodiment of the invention. In the depicted embodiment of FIG. 1, the two software systems may, for example, be software programs that include a Microsoft Windows OS and a One-Touch OS™ published by the assignee of the present invention.

The One-Touch OS™ is a user-friendly and easy-to-use software application program for the convenience of computer novices. The basic software design idea of the One-Touch OS™ is one-touch actuation of software functionalities. Such simple actuation interface is preferred by the majority of computer novice users. The one-touch actuation can be the single-press of a key on the keyboard of the computer. In an example of such an easy-to-use One-Touch OS™ application software, different sets of suitable keys of the keyboard can be assigned for different functionalities of the particular computer application. The principle for these key assignment is simplicity and clarity for computer novices.

An example of such a One-Touch OS™ features many daily-life computer applications aimed at providing hands-on experience and initiating the learning of computer use for computer novices. It has the functionality for processing daily-life computer applications that a computer-novice desires. Functionalities provided by such an easy-to-use application software system include the ability to process handy personal information such as phone numbers and addresses, take notes in texts or in drawings, provide basic communication services including telephone, facsimile, electronic mailing, chatting service over the network, and access to the popular World Wide Web over the Internet. The system also provides easy-to-use application systems for convenient learning and recreational sessions such as tutoring for personal skills such as language and typing, game playing, as well as audio and video playback.

A conventional OS, for example Windows, has a first data-exchanging software system generally identified as 120 that operates as an application running under the OS. The software system 120 comprises an OS data synchronization module 108, an OS data exchange module 106, an OS file access module 107, an OS exchange databank 105, and an OS standard-format databank 109. Note that information stored in databank 109 is in the standard format that is normally adopted by the OS for its file system and file structure.

On the other hand, as a second data-exchanging software system, the easy-to-use application software system, a One-Touch OS (™) for example, generally designated by reference numeral 110, has a set of its own software system building modules. These include an AP data synchronization module 103, an AP data exchange module 102, an AP exchange databank 101, and an AP standard-format databank 104. Here, again, information stored in databank 104 are in the standard format that is normally adopted by the application software system for its own file system and file structure.

Each of the two software systems 120 and 110 exchange data with each other so as to maintain synchronized copies of database of its own. A control program is used to achieve data synchronization between the two software systems.

Information collected and entered by the user that requires exchanging between the systems is stored in both databanks 105 and 101 of the OS 120 and the software system 110 respectively regardless of which system is used for information processing. Entering of an information record via one system, either OS 120 or software system 110, automatically effects the synchronization with the corresponding record in the other. Typical information to be kept in both databanks 105 and 101 may include records such as mails, agenda, date book, address lists and the like.

Each of the data exchange modules 106 and 102 retrieves its own version of data in its corresponding system for comparison with what has been in the database. Based on the result of the comparison, the data exchange modules can decide if a data exchanging is required. If the information compared is the same as in the database, there is no need for data exchange. If the information compared is found to be new, an exchange is then performed so as to update the database.

Data synchronization modules 108 and 103 are responsible for facilitating data synchronization for the OS 120 and the AP 110 respectively. They convert data records in their respective systems requiring exchange into data of its own standard format. The standard-format information can be accessed by the data exchange modules 106 and 102 of the software system of the other side.

Standard-format databanks 109 and 104 stores data records in the standard format of the respective software systems. Information that may be exchanged is stored in these databanks.

OS file access module 107 of the operating system 120 retrieves data records from the application software system 110. It retrieves data directly from the AP standard-format databank 104 recorded in AP standard data format.

In operation, a user 130 may interface with the computer via the application software system 110, a One-Touch OS for example, and determines whichever pieces of information are in need. AP data exchange module 102 of the system 110 then retrieves the corresponding data records directly from the OS standard-format databank 109 of the OS software system 120. Information retrieved in data records are then compared with the corresponding records in AP standard-format databank 104 by the software system 110. Based on the result of the comparison, the user can determine whether or not to update the information in AP databank 101.

When the user 130 concludes a session with the computer and exits from the application software system, the One-Touch OS for example, the AP data synchronization module 103 converts all the data records stored in databank 101 into standard format as a result of the user's decision and stores these converted records in the AP standard-format databank 104.

Should the user access information via the regular OS, the software system 120 in this case, the entire procedure is substantially similar except that the OS file access module 107 is involved in the process.

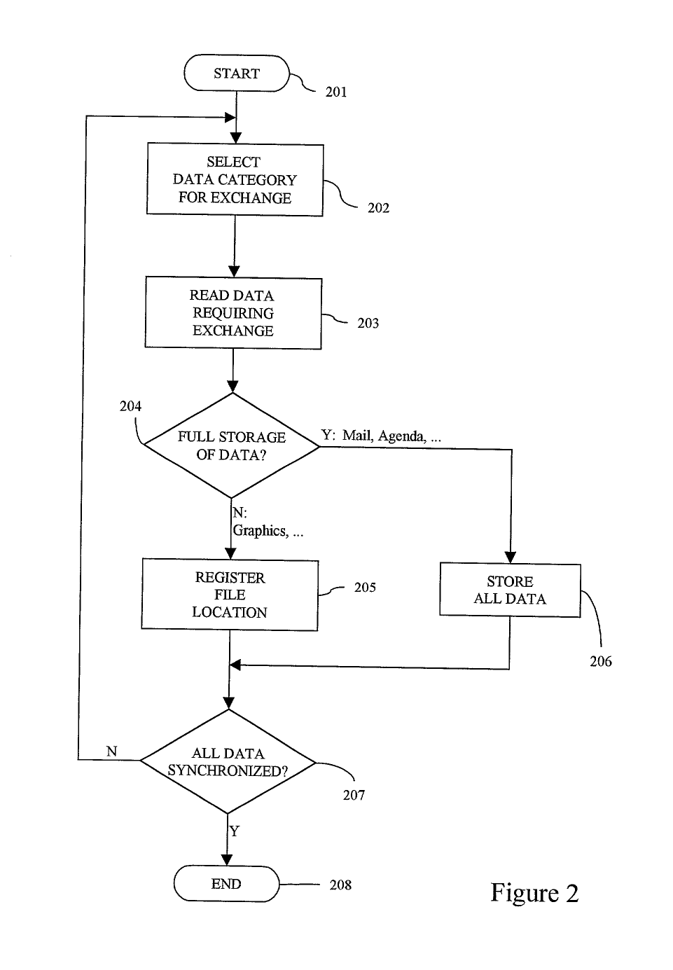

Operation of the OS and AP data synchronization modules 108 and 103 are substantially similar. They are used to synchronize all information that are altered due to access by the user in their respective software systems before the user concludes an information access session and exits the software system, either from OS 120 or AP 110, depending on which system is being used. This synchronization is necessary for maintaining data consistency in the two software systems. FIG. 2 is a flowchart illustrating the program flow of the data synchronization modules (OS 108 and AP 103) for the data exchange system of FIG. 1.

In the flowchart of FIG. 2, a data synchronization procedure starting at step 201 selects a data category that needs to be synchronized at step 202. At step 203, all data records in that category designated by the user as requiring synchronization processing are then retrieved from the databank, either OS exchange databank 105 or AP exchange databank 101. All retrieved data records are then inspected for their specific type at step 204 in a decision-making procedure. In general, the data can be divided into two types: one needs to have only their indices recorded, and the other needs a complete recording. Information including graphics and audio/video clips can have their record indices recorded instead of the entirety, while the other type including mail, agenda and address lists requires the recording of the entire record.

Thus, the program flow examines the type of the data to be synchronized at step 204 to determine if the data needs a simple indexing at step 205 or a full storage at step 206. Note that those records requiring only indexing instead of full storage can simply have their file locations recorded. File location information of graphics and multimedia files can be used as efficient entries in the database that maintains these files that are, in general, relatively large.

After a piece of information is synchronized, the program flow then checks at step 207 to see if all information requiring synchronization has been processed. If not, the process goes back to step 202 to initiate another cycle. If yes, the synchronization processing can be concluded at step 208.

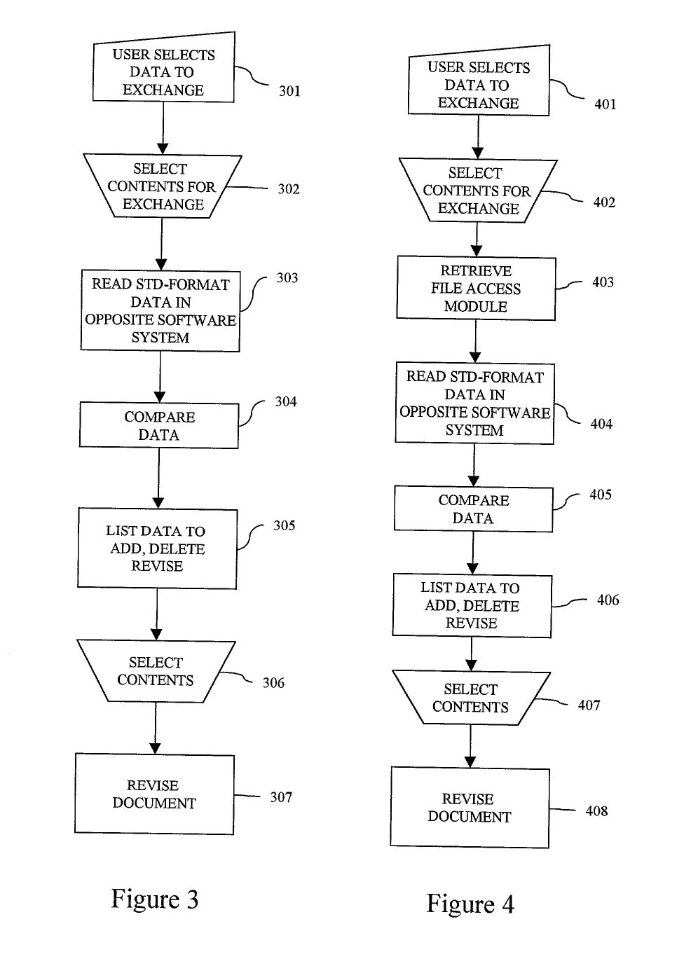

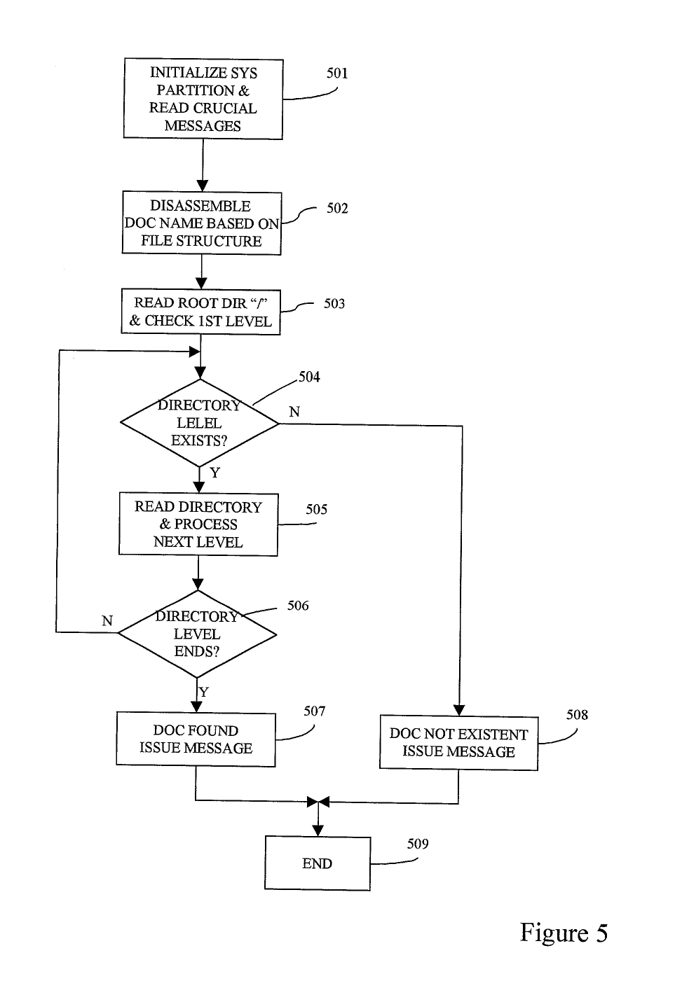

FIG. 3 is a flowchart illustrating the program flow of the data exchange module for exchanging data in the software system 110 of the data exchange system of FIG. 1. In contrast, FIG. 4 is a flowchart for exchanging data in the operating system 120 of FIG. 1. Both software systems 120 and 110 implement the similar data exchanging functionality respectively as required by the situation.

When the computer is newly installed with a software system of the invention, there is normally no information record stored in the databases. Eventually, the user builds up the information database regardless of whichever of the software systems 120 and 110 is used.

In general, as the user stores a piece of information in the computer using one software system, either OS 120 or AP 110, a corresponding piece of information is automatically generated in the other software system. Similarly, any piece of information being revised or deleted in one system will also be correspondingly revised or deleted in the other. These synchronization tasks are performed by both software systems via their respective data exchange modules (106 and 102).

The straight-forward data exchange processing flowchart of FIG. 3 performs the data exchange operation for the application software system 110 of FIG. 1. At step 301, the user selects the information to be exchanged. Once selected, the content of that specific piece of information is inspected at step 302 to determine the portions of the content that require exchanging. Then, at step 303, the standard-format databank 109 of the opposite software system is accessed for the required data. The process may go through the entire record lists in the databank comparing each entry, as is illustrated in step 304.

If one record is missing in the software system 110 but present in the other, 120, it is considered a deleted record, but, if one record is present in the database of the software system 110 but missing in the other, 120, it is considered an added record. If one record has a content in system 110 that is different from the other in system 120, it is considered altered or updated. The addition, deletion and revision of data records as thus detected in one software system in steps 305 and selected in step 306 may then be respectively implemented at step 307.

The data exchange procedure performed by the OS data exchange module 106 of the operating system 120 is, in general, substantially similar to that performed by the AP data exchange module 102 described above. The only difference is the involvement of the OS file access module 107 in the process. The straightforward data exchange processing flowchart of FIG. 4 illustrates the data exchange operation for the operating system 120 of FIG. 1.

At step 401, the user selects the information to be exchanged. Once selected, the content of that specific piece of information is inspected at step 402 to determine the portions of the content that require exchanging. Then, at step 403, the standard-format databank of the opposite software system 104 is accessed for the required data via engaging the OS file access module 107 (refer to FIG. 1). The process may go through the entire record lists in the databank comparing each entry, as is illustrated in step 405.

If one record is missing in the operating system 120 but present in the other, is 110, it is considered a deleted record, but if one record is present in the database of system 120 but missing in the other, 110, it is considered an added record. If one record has a content different from the other, it is considered altered or updated. The addition, deletion and revision of data records as thus detected in one software system in steps 406 and 407 may then be similarly implemented in the other, at step 408.

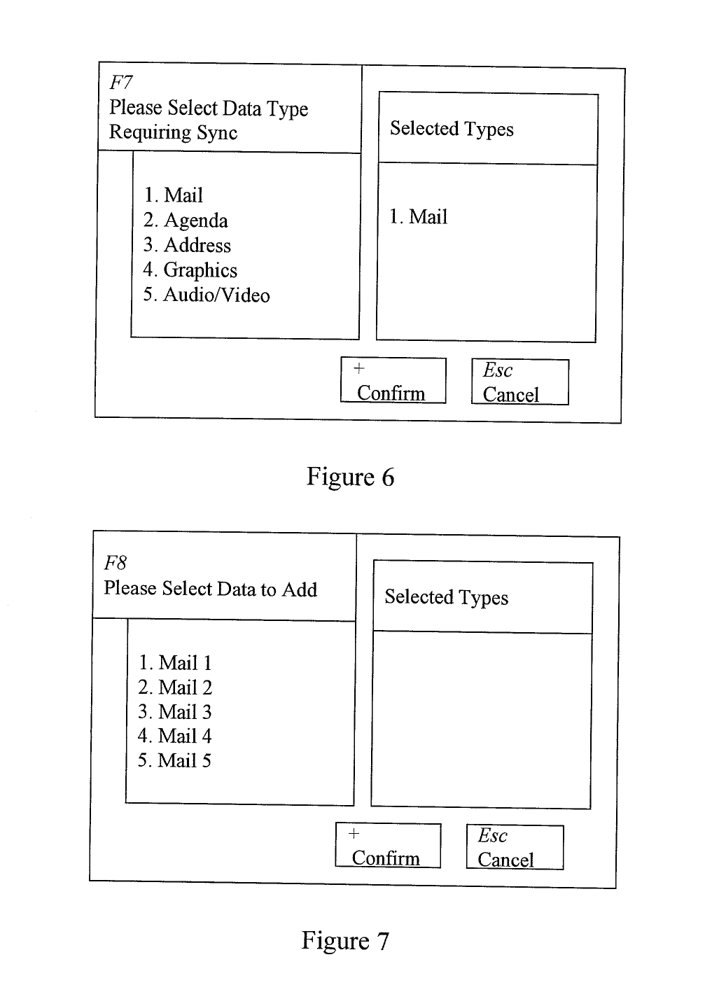

FIG. 5 is a flowchart illustrating the program flow of the OS file access module for the data exchange system of FIG. 1. In the system of FIG. 1, the file access module 107 is a program module installed in the operating system 120. It is used to implement access at the OS level to information established by the user that has been exchanged. As the operating system 120 needs to access the information established by the user in the application software system 110, the information stored in document of the software system 110 has to be read and stored as temporary files in the OS 120. This requires examining into the specific directory in the file system of the software system 110. The OS file access module 107 is set up to perform this task.

Consider, for example, the process of searching for the document file “/etc/rd.d/rc.local” within the partition “/dev/hda2.” Here, as is known to persons skilled in the art, the partition designation “/dev/hda2” is typically referring to the second partition (2) on the first (a) standard hard drive (hd) of the devices (dev) mounted for a Unix operating system such as Linux. For a description of this process, reference can be made to FIG. 5. At step 501, the system partition is initialized and the crucial messages read in. Then, at step 502, the document file to be located, whose identification bearing string the “/etc/rc.d/rc.local” is disassembled into segments of three different levels “etc,” “rc.d” and “rc.local”. Next, at step 503, the root “/” of the system is looked into in order to locate the directory “etc.” Step 504 examines to see whether or not such a directory is present in the system. If there is no such directory “etc” existing in the file system, the process proceeds to step 508 to conclude that the seek for the document file “/etc/rc.d/rc.local” has failed and an error message is issued. The process then advances to step 509 and the program concludes.

If, on the other hand, the test step 504 returns a positive result, namely, the directory “etc” indeed exists, then the program proceeds to step 505 to read the next level of directory, i.e., “rc.d” of the sought document file. Then, in step 506, the program checks to see if this is the last level in the directory name string. If positive, the entire string of the document name has been gone through completely, and the program issues a message indicating the successful positioning of the document file at step 507, and the program may then conclude at step 509.

If the test step 506 returns a negative result indicating that the search through the entire document name string has not yet been completed, the program will be returned to step 504 to see, if the next level of the document name string, i.e., the subdirectories “rc.d” and “rc.local” are in existence.

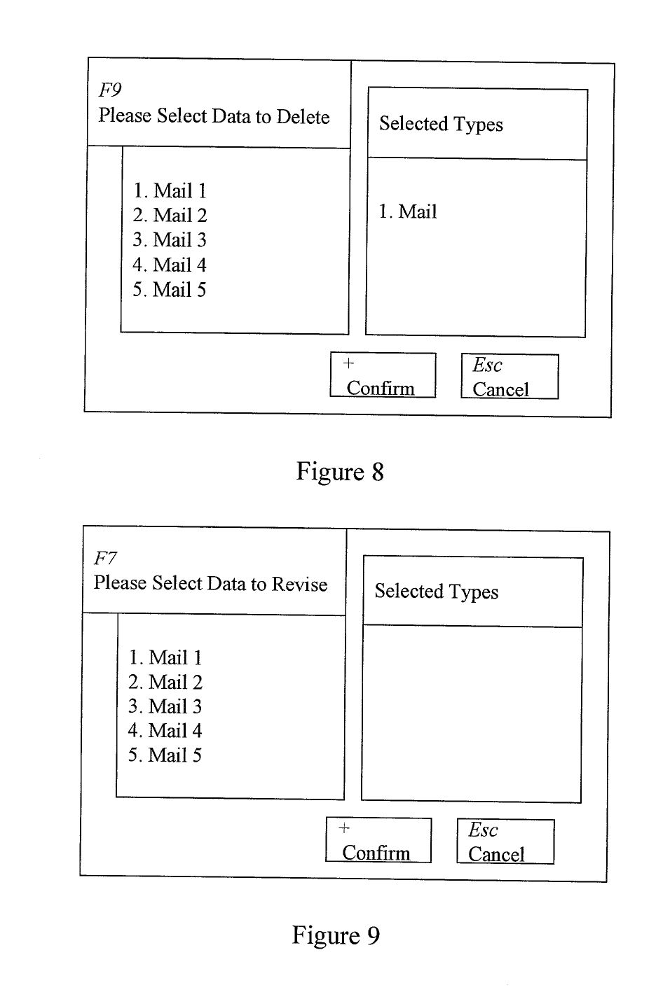

FIGS. 6-9 respectively show selected exemplary screen shots of an embodiment of the data exchange system of the invention in the process of handling of mail messages. FIG. 6 is an example of a screen layout allowing the exchange of mail messages between the OS and the application software systems that reside on the same computer. In the process, after a user requests for information requiring synchronization among the two software systems, a screen similar to the one outlined in FIG. 6 appears that prompts the user to select the type or types of information that need exchanging.

If, for example, the user determines that mail, a particular type of information, is the type that needs exchange processing, the user may indicate this requirement to the system by pressing the “1” key, which, as shown, represents the type for “mail,” on the computer keyboard. If, as is shown in the screen of FIG. 6, there is only the type “mail” that requires exchanging, the user may depress the “+” key to confirm to the system that the selection is complete. Upon reception of this input, the computer conducts an internal comparing operation, and as a result of this comparison, outputs a list of all mail messages 1, 2, . . . and so on that allows the user to select for updating.

Then, as an example shown in FIG. 7, the user may be prompted for the input of the mail messages that require addition into the system information database. In the left-hand-side window of the screen of FIG. 7, a list of numbered mail messages are outlined for user's selection. By simply depressing the numeric keys on the computer keyboard, desired mail messages may be selected and appears in the right-hand-side window as “Selected Records.” Upon completion of the selection, the user, again, may indicate this conclusion by depressing the confirmation key “+.”

As another example, on the other hand, the user may also select those mail messages that are to be deleted from the computer database, as is shown in FIG. 8. Upon selection of the function of mail message deletion, a screen similar to that shown in FIG. 8 may be displayed by the system for this service. The user may be prompted for the input of the mail messages that require deletion from the system information database. In the left-hand-side window of the screen of FIG. 8, a list of numbered mail messages are outlined for user's selection. Simply depressing the numeric keys on the computer keyboard, desired mail messages may be selected and appear in the right-hand-side window as “Selected Records.” Upon completion of selection, the user indicates this conclusion by depressing the confirmation key “+.” Once confirmed, the mail messages listed in the “Selected Records” window in FIG. 8 can be deleted.

Further, as another example, the user may select mail messages that require revision or modification. As is shown in FIG. 9, the screen lists mail messages to be selected for revision in the left-hand-side of the screen. Again, mail messages are numbered in this window for user's selection. Those to be revised can be selected by pressing numeric keys representing them. Selected mail messages appear in the right-hand-side window of FIG. 9. A “+” key confirms the total selection of mail messages to be revised which are listed in the right-hand-side window. Subsequent program functionality will allow the user to effect such revisions as necessary.

In summary, a data exchange system in accordance with a preferred embodiment of the invention for exchanging data between two software systems running on a computer may be used for maintaining data consistency in databases in the two software systems in real-time. The data exchange system comprises a first and second data-exchanging software systems. First one of them may be a software program operating directly under a popular OS such as Windows or Linux. The second may be the one that is designed with user-friendliness as the utmost consideration, thereby providing a “dual-OS” system that even computer novices will like to use.

The first data-exchanging software system operates as an application software under the Microsoft Windows or Linux operating system of the computer and comprises an OS data synchronization module, an OS data exchange module, an OS exchange databank, and an OS standard-format databank. The second data-exchanging software system operates as another application software under the One-Touch OS™ operating system and comprises an AP data synchronization module, an AP data exchange module, an AP exchange databank, and an AP standard-format databank. The OS data exchange module accesses information stored in the AP standard-format databank for comparison with information stored in the OS exchange databank. The OS data synchronization module synchronizes the compared information designated by a user of the computer, and the AP data exchange module accesses information stored in the OS standard-format databank for comparison with information stored in the AP exchange databank. The AP data synchronization module synchronizes the compared information designated by the user.

While the above is a full description of the specific embodiments, various modifications, alternative constructions and equivalents may be used. Therefore, the above description and illustrations should not be taken as limiting the scope of the present invention which is defined by the appended claims.

What is claimed is:

1. A data exchange system for exchanging data between two software systems running on a computer having an operating system for maintaining data consistency in a plurality of databases in said two software programs in real-time, said data exchange system comprising:
a first data-exchanging software system operating as an application software under the operating system of said computer and comprising an OS data synchronization module, an OS data exchange module, an OS exchange databank, and an OS typical-format databank; and
a second data-exchanging software system operating as an application software under said operating system of said computer and comprising an AP data synchronization module, an AP data exchange module, an AP exchange databank, and an AP standard-format databank; wherein
said OS data exchange module accesses information stored in said AP standard-format databank for comparison with information stored in said OS exchange databank, and said OS data synchronization module synchronizes said compared information designated by a user of said computer, and said AP data exchange module accesses information stored in said OS standard-format databank for comparison with information stored in said AP exchange databank, and said AP data synchronization module synchronizes said compared information designated by said user.

2. The data exchange system of claim 1, wherein said first data-exchanging software system further comprises an OS file access module, said OS data exchange module accessing said information stored in said AP standard-format databank by accessing said OS file access module for direct access into said AP standard-format databank.

3. The data exchange system of claim 1, wherein said second data-exchanging software system is a user-friendly application software system incorporating a plurality of simple interfaces for intuitive access by computer users.

4. The data exchange system of claim 3, wherein said second data-exchanging software system is a user-friendly One-Touch OS application software system for processing daily-life computer applications for computer users.

5. The data exchange system of claim 4, wherein said One-Touch OS application software system processes handy personal information including phone numbers and addresses.

6. The data exchange system of claim 4, wherein said One-Touch OS application software system takes notes.

7. The data exchange system of claim 4, wherein said One-Touch OS application software system provides communication services.

8. The data exchange system of claim 4, wherein said One-Touch OS application software system provides chatting service over the Internet.

9. The data exchange system of claim 4, wherein said One-Touch OS application software system provides access to the World Wide Web over Internet.

10. The data exchange system of claim 4, wherein said One-Touch OS application software system provides language tutoring to computer users.

11. The data exchange system of claim 4, wherein said One-Touch OS application software system provides typing tutoring to computer users.

12. The data exchange system of claim 4, wherein said One-Touch OS application software system provides game playing to computer users.

13. The data exchange system of claim 4, wherein said One-Touch OS application software system provides multimedia playback.

14. The data exchange system of claim 4, wherein said One-Touch OS application software system is capable of processing handy personal information including phone numbers and addresses, taking notes in texts and in drawings, providing communication services including telephone connections, facsimile transmissions and receptions, electronic mailing, chatting service over the Internet, accessing the World Wide Web over the Internet, providing language tutoring and typing tutoring to computer users, providing game play to computer users, and providing audio and video playback.

15. A data exchange system for exchanging data between two software systems running on a computer for maintaining data consistency in databases in said two software systems in real-time, said data exchange system comprising:
a first data-exchanging software system operating as an application software under the operating system of said computer and comprising an OS data synchronization module, an OS data exchange module, an OS file access module, an OS exchange databank, and an OS standard-format databank; and
a second data-exchanging software system operating as an application software under said operating system and comprising an AP data synchronization module, an AP data exchange module, an AP exchange databank, and an AP standard-format databank; wherein
said OS data exchange module accesses information stored in said AP standard-format databank for comparison with information stored in said OS exchange databank, said OS data exchange module accesses said information stored in said AP standard-format databank by accessing said OS file access module for direct access into the file system of said AP standard-format databank, and said OS data synchronization module synchronizes said compared information designated by a user of said computer, and said AP data exchange module accesses information stored in said OS standard-format databank for comparison with information stored in said AP exchange databank, and said AP data synchronization module synchronizing said compared information designated by said user.

16. The data exchange system of claim 15, wherein said second data-exchanging software system is an easy-to-use application software system incorporating simple interface for easy and intuitive access by computer users.

17. In a data exchange system for exchanging data between two software systems running on a computer, said computer having an operating system for maintaining data consistency in a plurality of databases in said two software programs in real-time, and said data exchange system comprising a first and as second data-exchanging software system wherein said first data-exchanging software system comprising an OS data synchronization module, an OS data exchange module, an OS exchange databank and an OS standard-format databank, and said second data-exchanging software system comprising an AP data synchronization module, an AP data exchange module, an AP exchange databank and an AP standard-format databank, a method for exchanging data between two software systems of said data exchange system comprising the steps of:
said first data-exchanging software system operating as an application software under the operating system of said computer;
said second data-exchanging software system operating as an application software under said operating system of said computer; and
said OS data exchange module accessing information stored in said AP standard-format databank for comparison with information stored in said OS exchange databank, and said OS data synchronization module synchronizing said compared information designated by a user of said computer, and said AP data exchange module accessing information stored in said OS standard-format databank for comparison with information stored in said AP exchange databank, and said AP data synchronization module synchronizing said compared information designated by said user.

18. The method for exchanging data of claim 17, wherein said OS data exchange module accessing said information stored in said AP standard-format databank by accessing said OS file access module for direct access into said AP standard-format databank.

19. The method for exchanging data of claim 17, wherein said second data-exchanging software system is a user-friendly application software system incorporating a plurality of simple interfaces for intuitive access by computer users.

20. The method for exchanging data of claim 19, wherein said second data-exchanging software system is a user-friendly One-Touch OS application software system for processing daily-life computer applications for computer users.

21. The method for exchanging data of claim 19, wherein said One-Touch OS application software system processes handy personal information including phone numbers and addresses.

22. The method for exchanging data of clai 19, wherein said One-Touch OS application software system takes notes.

23. The method for exchanging data of claim 19, wherein said One-Touch OS application software system provides communication services.

24. The method for exchanging data of claim 19, wherein said One-Touch OS application software system provides chatting service over the Internet.

25. The method for exchanging data of claim 19, wherein said One-Touch OS application software system provides access to the World Wide Web over Internet.

26. The method for exchanging data of claim 19, wherein said One-Touch OS application software system provides language tutoring to computer users.

27. The method for exchanging data of claim 19, wherein said One-Touch OS application software system provides typing tutoring to computer users.

28. The method for exchanging data of claim 19, wherein said One-Touch OS application software system provides game playing to computer users.

29. The method for exchanging data of claim 19, wherein said One-Touch OS application software system provides multimedia playback.

30. The method for exchanging data of claim 19, wherein said One-Touch OS application software system is capable of processing handy personal information including phone numbers and addresses, taking notes in texts and in drawings, providing communication services including telephone connections, facsimile transmissions and receptions, electronic mailing, chatting service over the Internet, accessing the World Wide Web over the Internet, providing language tutoring and typing tutoring, providing game playing, and providing audio and video playback.
